(19) United States
(12) Patent Application Publication
(10) Pub. No.: US 2002/0046293 A1
(43) Pub. Date: Apr. 18, 2002

(54) Web on-demand system

(76) Inventors: Takeshi Kabata, Tokyo (JP); Yoshisuke Ishiuchi, Ichikawa-shi (JP)

Correspondence Address: RABIN & CHAMPAGNE, PC, 1101 14TH STREET, NW, SUITE 500, WASHINGTON, DC, 20005, US

(21) Appl. No.: 09/891,614

(22) Filed: Jun. 27, 2001

(30) Foreign Application Priority Data
Jul. 17, 2000 (JP) 2000-215491

(51) Int. Cl. G06F 15/16

(52) U.S. Cl. 709/245; 709/230

(57) ABSTRACT

In a Web on-demand system, even a client terminal whose IP address is not fixed can provide Web in response to an inquiry using a host name from a user terminal. A Web on-demand server receives, from a client terminal, client information including an IP address assigned to the client terminal by an Internet service provider and arbitrary host name, and transmits the client information to a DNS server to register the information. When the DNS server which maintains fully qualified domain names assigned by the Internet service provider receives an inquiry using a host name from a user terminal, it returns a corresponding IP address.

### BACKGROUND OF THE INVENTION

1. Field of the Invention

The present invention relates to a system for providing a Web-providing network service or the like (hereinafter referred to simply as Web) and, more particularly, to a Web-on demand system which makes it possible to easily provide Web through a terminal whose IP address is not fixed.

2. Description of the Related Art

In the Internet, Internet Protocol (IP) addresses are used to enable each of computers connected to the Internet to be uniquely identified. However, IP addresses are each a simple sequence of figures having no connotation and not easy to remember. Therefore, a sequence of characters called a fully qualified domain name is used. A fully qualified domain name is a sequence of characters (e.g., abc.ami.co.jp) consisting of a combination of a domain name (ami.co.jp) and a host name (abc). A host name and an IP address are registered in a domain name system (DNS) server by being related to each other to enable location of a computer from a fully qualified domain name. A domain name is registered in a network information center (NIC). Ordinarily, a fully qualified domain name is called a host name.

To use a host name, acquisition of a domain name and registration of the domain name in a DNS are required. When a host name is acquired, a machine given the host name can be related to a unique IP address on the Net. On the other hand, in the case of dial-up connection of a machine, one of IP addresses belonging to a commercial access provider is assigned to the machine by the commercial access provider only during sustention of the connection. After the termination of the connection of one machine, the IP address belonging to the commercial access provider is assigned to another machine. In this case, therefore, a host name cannot be used. Also in a case where a DHCP (dynamic host configuration protocol) server is used, a host name cannot be used since an IP address is changed after the end of a term set for use of the IP address.

### SUMMARY OF THE INVENTION

It is, therefore, an object of the present invention to provide a Web on-demand system which makes it possible to easily provide Web through a terminal whose IP address is not fixed.

To achieve the above-described object, according to the present invention, there is provided a Web on-demand system arranged to receive client information including an IP address assigned to a client terminal and an arbitrary host name from the client terminal through the Internet, and to return the IP address in response to an inquiry as to the host name from a user terminal connected to the Internet while the client terminal is connected to the Internet.

In the Web on-demand system of the present invention, when a user terminal inquires of the Web on-demand system about a host name of a client terminal, the Web on-demand system returns an IP address corresponding to the host name contained in client information transmitted from the client terminal. The user terminal is thereby informed of the IP address of the client terminal to connect to the client terminal.

In the Web on-demand system of the present invention, therefore, even a client terminal whose IP address is not fixed can provide Web in response to an inquiry with a host name from a user terminal.

The above-described Web on-demand system may comprise Web on-demand management server module for receiving client information and for monitoring the state of connection of a client terminal to the Internet, and DNS server module for newly registering an IP address and a host name with respect to one client terminal supplied from the Web on-demand management server module while relating the IP address and the host name to enable returning of the IP address in response to an inquiry about the host name from a user terminal connected to the Internet, and for deleting the registration of the client terminal when supplied with information that the connection of the client terminal to the Internet has been cut as information on the state of connection from the Web on-demand management server module. The IP address may be one assigned by an Internet service provider when the client terminal is connected to the Internet in a dial-up connection manner, or one unique to the client terminal. The present invention is applied particularly effectively to a client terminal whose IP address is changed each time it is used. A host name may be transmitted together with an IP address each time a client terminal uses the Web on-demand system. Alternatively, host names may be previously transmitted and registered in a Web on-demand server while being respectively related to client terminals. Each host name is newly registered by the DNS server module by being combined with a domain name maintained by the DNS server module to form a fully qualified domain name. A user terminal makes an inquiry using a fully qualified domain name or a URL.

Further, the Web on-demand system may be arranged to provide a directory including host names at a request from a user terminal connected to the Internet while the corresponding client terminal is connected to the Internet. The user terminal can be connected to the client terminal by referring to the directory, even if it has not previously been informed of the host name. The user terminal can also be informed that the client terminal provides Web.

To perform such functions, the Web on-demand system may be arranged to have Web on-demand management server module for receiving client information and for monitoring the state of connection of a client terminal to the Internet, and directory server module for newly registering a URL including a host name supplied from the Web on-demand management server module to enable returning of a directory including the URL at a request from a user terminal connected to the Internet, and for deleting the registration of the client terminal when supplied with information that the connection of the client terminal to the Internet has been cut as information on the state of connection from the Web on-demand management server module. The client information may include a title and genre information about Web which the client terminal will provide to the user terminal, and the directory may be formed by using the title and the genre information, thereby facilitating a search for a URL from the user terminal. The URL is formed of a combination of a protocol, a host name and an address name.

Further, a URL list in which a symbol for identification of a user terminal and a URL including a particular host name are entered by being related to each other may be prepared in advance, and, when client information is transmitted from a client terminal, the user terminal related to the host name is informed that client information has been transmitted from the client terminal. The user terminal is thereby informed of the state of Web becoming available through the client terminal.

Further, a determination is made as to whether a client terminal is connected to the Internet from an alive signal periodically transmitted from the client terminal and/or an off-line signal transmitted from the client terminal when the client terminal is made off-line. The Web on-demand system is immediately informed of the state of the client terminal made off-line to effectively utilize the resources for the Web on-demand system.

In the Web-on demand system according to the present invention, a client terminal whose IP address is not fixed can provide Web at a request with a host name from a user terminal.

### BRIEF DESCRIPTION OF THE DRAWINGS

In the accompanying drawings:

FIG. 1 is a block diagram showing essential components of a Web on-demand system according to one embodiment of the present invention;

FIG. 2 is a diagram showing the procedure of enabling a user terminal to be connected to a client terminal with a host name in the Web on-demand system shown in FIG. 1; and

FIG. 3 is a diagram showing the procedure of establishing a connection between a user terminal and a client terminal by using a host name in the Web on-demand system shown in FIG. 1.

### DESCRIPTION OF THE PREFERRED EMBODIMENT

A Web on-demand system according to an embodiment of the present invention will be described with reference to the accompanying drawings.

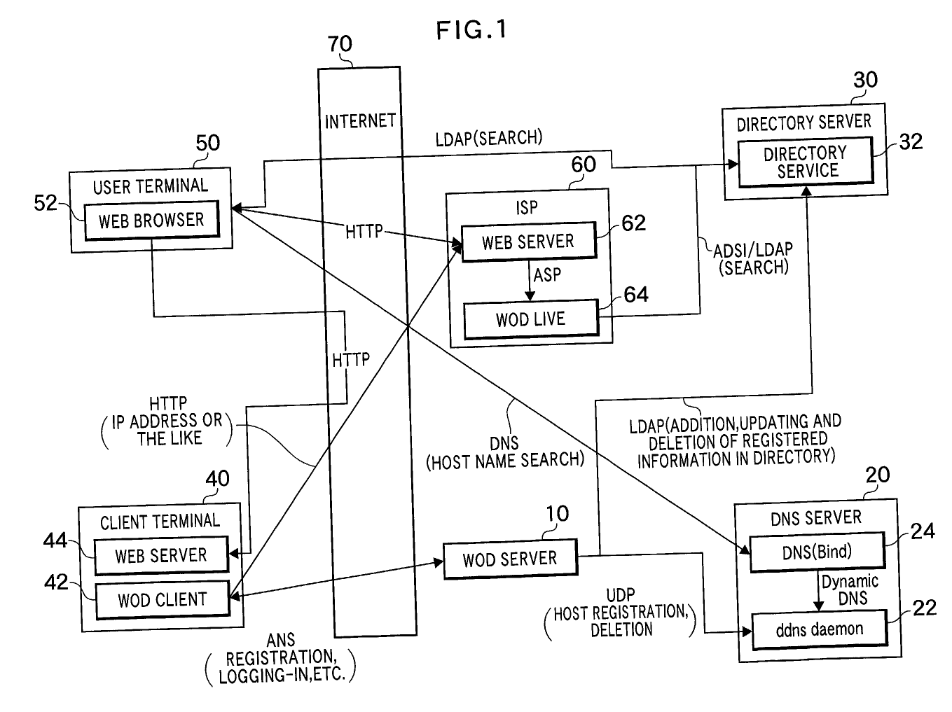

FIG. 1 is a block diagram showing main components of the Web on-demand system according to an embodiment of the present invention.

Referring to FIG. 1, the Web on-demand (WOD) system has a WOD server 10 which monitors and controls the operation of each of terminals and servers, a DNS server 20 which receives information from the WOD server 10 and registers an IP address and a host name by relating them to each other, and a directory server 30 which receives information from the WOD server 10 to form a directory. These servers may be provided as modules constituting one physically united apparatus or as a plurality of computers physically separated from each other and connected to each other through a local area network (LAN) or the Internet.

A client terminal 40 which functions as a Web server through this WOD system is connected to an Internet service provider (ISP) 60 via a dial-up line to be connected to the WOD server 10 through the Internet 70. A user terminal 50 capable of using the client terminal 40 as a Web server is connected to the ISP 60, to the DNS server 20, to the directory server 30, and to the client terminal 40 through the Internet 70. Each of these terminals is a device connectable to the Internet, e.g., a personal computer or a portable telephone. These terminals can be connected to the Internet in a dial-up connection manner. When one of these terminals is connected to the Internet, it is first connected to the ISP 60 and then assigned one of IP addresses belonging to the ISP 60, and can use the assigned IP address until the connection is cut. In this embodiment, the ISP 60 is physically combined with a server. However, the ISP 60 and the server may, of course, be provided separately from each other. A domain name of the ISP 60 is maintained by the DNS server 20. For example, in a case where the client terminal 40 is assigned an IP address by another commercial ISP, a DNS server which maintains a domain name of the commercial ISP is connected to the WOD server 10 to transmit information. The ISP 60 has a Web server 62 and a WOD LIVE 64. The Web sever 62 gives an IP address to the client terminal 40 or the user terminal 50 in response to hyper text transfer protocol (HTTP) accessing from the terminal. The WOD LIVE 64 is an active server page (ASP) script for making a search in a directory of the directory server 30. For the search, active directory services interface (ADSI) library is used. The WOD LIVE 64 is used to make a search for a host name from a top page displayed by the Web server 62 at the time of HTTP accessing from a terminal.

The WOD server 10 receives from the client terminal 40 client information including an IP address assigned to the client 40 and an arbitrary host name. The client information contains a password, a mail address, and a Web title and genre information which the client terminal 40 will provide. Also, the WOD server 10 monitors the state of connection of the client terminal 40 to the Internet. That is, the WOD server 10 makes a determination as to whether the client terminal 40 is connected to the Internet from an alive signal periodically transmitted from the client terminal 40 and an off-line signal transmitted from the client terminal 40 when the client terminal is made off-line to thereby obtain connection information. Thus, the WOD server 10 can immediately get to know the off-line state of the client terminal 40 and can therefore prevent an increase in the load on the WOD system due to the client terminal 40 not connected thereto.

An IP address may be assigned to the client terminal 40 by the ISP 60 when the client terminal 40 is connected to the Internet in a dial-up connection manner, as described above, or the client terminal 40 may have an IP address specially given to it. A host name may be transmitted together with an IP address each time the client terminal 40 uses the Web on-demand system. Alternatively, host names may be transmitted from a plurality of client terminals 40 to be registered in the WOD server 10 by being respectively related to the client terminals 40. To previously register host names, the WOD server 10 makes a search to check whether the same host name as one of the host names to be registered has previously been registered in the DNS server 20. If the same name has been registered, the WOD server 10 requires the client terminal 40 to select a different host name. For example, this registration is performed through the Internet at the time of WOD system signing-up by the client terminal 40 or at the time of installation of software for using the WOD system. Simultaneously, the client terminal 40 is required to incorporate a sequence of identification characters for its terminal identification, and to register a password and a user ID. Also in the case where the host name of the client terminal 40 is transmitted together with an IP address each time the client terminal 40 is used, the WOD server 10 also makes a search in the DNS server 20 to check whether the same name has already been registered.

Further, the WOD server 10 may be arranged to prepare a uniform resource locator (URL) list in which symbols for identification of user terminals 50 and URLs containing particular host names are entered while being related to each other. When client information containing an IP address is transmitted from one of the client terminals 40 to start provision of Web, the WOD server 10 informs the user terminal 50 related to the corresponding host name that the client information has been transmitted from the client terminal 40. In this manner, the user terminal 50 can be informed that it becomes possible to use Web provided by the client terminal 40. The URLs are made by the directory server 30 described below. Also, the WOD server 10 transmits the IP address and the host name in the client information to the DNS server 20 and transmits to the directory server 30 the IP address, the host name, the title and genre information or the like of Web that the client terminal 40 will provide.

The DNS server 20 newly registers in a DNS 22 an IP address and a host name with respect to one client terminal 40 supplied from the WOD server 10. Updating of the DNS 22 is performed by a ddns daemon 24. The ddns daemon 24 receives an IP address and a host name in accordance with user datagram protocol (UDP) from the WOD server 10 and performs DNS updating by using nsupdate commands on the server. Specifically, host names are registered in the form of a fully qualified domain name by being combined with the domain name of the WOD server 10 maintained by the DNS server 20. When the DNS server 20 receives an inquiry about a fully qualified domain name from the user terminal 50 connected to the Internet, it returns the corresponding IP address in response to the inquiry. When the DNS server 20 is supplied by the WOD server 10 with connection state information that the connection of one client terminal 40 to the Internet has been cut, it deletes the registration of the client terminal 40.

While one client terminal 40 is being connected to the Internet by transmitting client information to the WOD server 10, the directory server 30 provides a directory including a host name transmitted by the client terminal 40 at a request from the user terminal 50 connected to the Internet 70. A lightweight directory access protocol (LDAP) server 32 included in the directory server 30 performed addition, updating or deletion in the directory with respect to the client information sent in accordance with LDAP from the WOD server 10. The host name is registered in the directory server 30 in the form of a URL containing the host name. Then the user terminal 50 can connect to the client terminal 40 by referring to the directory even if it has not been informed of the host name, and can be informed that the client terminal 40 is providing Web. When the directory server 30 is supplied by the WOD server 10 with connection state information that the connection of the client terminal 40 to the Internet 70 has been cut, it deletes the registration of this client terminal.

The client terminal 40 has a WOD client 42 and a Web server 44. The Web server 44 transmits Web which is to be provided from the client terminal 40 through the WOD system. However, information transmitted by the client terminal 40 is not limited to Web, and file transport protocol (FTP) or the like may be transmitted from the client terminal 40. In such a case, the Web server 44 is replaced by an FTP server or the like. The WOD client 42 is a module suitable for easy use of the WOD system and capable of performing a browsing function, a user registration function, a client information transmitting function, etc. The user terminal 50 includes a Web browser 52.

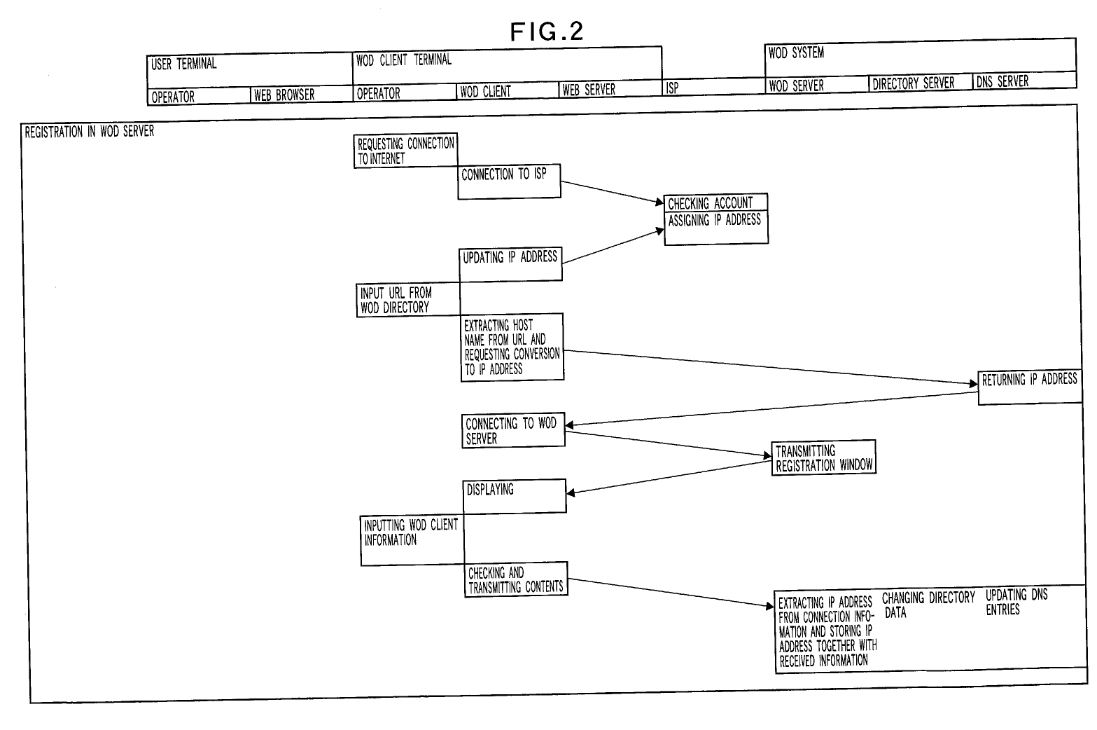

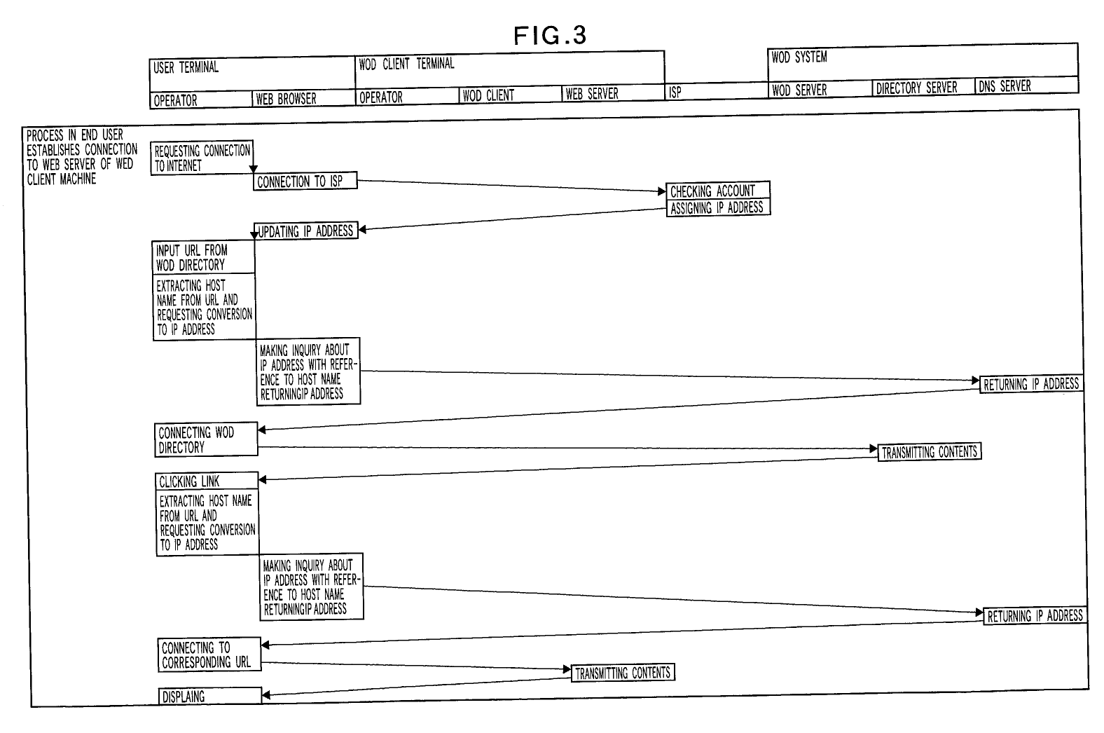

A Web provision process performed by the WOD system shown in FIG. 1 will next be described with reference to FIGS. 2 and 3.

FIG. 2 shows the procedure of establishing a connection to the WOD system by the client terminal 40. First, an operator makes an Internet connection request by operating the client terminal 40. The WOD client 42 performs HTTP accessing to the ISP 60, and the ISP 60 performs accounting to assign an IP address. The WOD client 42 performs IP address updating. These steps are the same as those in the procedure of ordinary dial-up connection through a browser.

Next, the operator inputs the URL of the WOD server 10 to the client terminal 40 to use the WOD system. The WOD client 42 extracts a host name from the input URL and makes a request to DNS server 20 for conversion to an IP address. The DNS server 20 returns the IP address corresponding to the host name in response to the request, and the WOD client 42 establishes a connection to the WOD server 10 by using the returned IP address. The WOD server 10 transmits a registration window to the client terminal 40. This registration window is a window for inputting client information through the client terminal 40. The operator inputs necessary client information by inputting characters, checking a check box, selecting an item in a pull-down menu, etc. with instructions given through the registration window displayed on the client terminal 40. The WOD server 10 may simultaneously require the client terminal 40 to transmit a sequence of identification characters incorporated in the client terminal 40 to enable identification of the terminal. The client information includes a password, a mail address, a title and genre information about Web, an additional genre information, other additional information, etc. A host name is input if no host name has been registered in the WOD client 42. An IP address is also included in the client information but it is automatically transmitted without requiring inputting by the operator.

The WOD client 42 checks the client information input by the operator and transmits the client information to the WOD server 10 if there is no problem. The WOD server 10 receiving the client information transmits the host name and the IP address in the client information to the DNS server 20, and transmits the host name, the Web title and genre information, etc., to the directory server 30.

The DNS server 20 receiving the host name and the IP address registers the host name and the IP address in the DNS 22 by relating the host name and the IP address to each other. The host name is registered in the form of a fully qualified domain name in which the host name is combined with the domain name maintained by the DNS server 20.

The directory server 30 sorts the client information on the basis of the genre information and enters the host name and the Web title and genre information in sorted files. It is possible to select from the client terminal 40 registering or not the client information in the directory server 30. To execute this, information on changeover between open and secret states is sent from the WOD client 42 to the WOD server 10 by being included in the client information or separately from the client information.

The above-described state is maintained and the WOD server 10 monitors the state of connection of the client terminal 40 as long as the client terminal 40 does not cut the connection to the Internet. That is, the WOD client 42 transmits to the WOD server 10 an alive signal at intervals of five minutes after being enabled to provide Web as described above. If the alive signal is not received from the client terminal 40 over ten minutes or more, the WOD server 10 determines that the client terminal 40 is disabled to provide Web for some reason, and deletes the registration of the client terminal 40. The intervals at which the alive signal is transmitted can be changed, as well as the wait time before deletion of the registration. When the operator stops providing Web, an off-line request is sent from the WOD client 42 to the WOD server 10 by an operator's operation, thereby deleting the registration of the client terminal 40. The deletion of the registration of the client terminal 40 is performed by the WOD server 10 deleting the host name, the IP address and other client information about the client terminal 40 from the DNS server 20 and the directory server 30.

The procedure of establishing a connection to the client terminal 40 by the user terminal 50 will next be described with reference to FIG. 3. The connection to client terminal 40 as seen from user terminal 50 is substantially the same as the ordinary connection to the Web server, and no special operation or software is required for the connection.

First, when an operator makes an Internet connection request, the Web browser 52 establishes a connection to the ISP 60, and the ISP 60 makes an account check to assign an IP address, thereby performing IP address updating. An IP address may be obtained from any other commercial ISP, and the user terminal 50 may have a global IP address, as mentioned above.

Next, the operator inputs the URL of the directory server 30 to establish a connection to the directory server 30. A host name is extracted from the input URL and the DNS server 20 is inquired about the IP address with reference to the host name. The DNS server 20 makes a search for the IP address of the directory server 30 and returns the IP address to the Web browser 52. The Web browser 52 establishes connection to the directory server 30 by using this IP address.

The directory server 30 transmits the contents of the directory to the Web browser 52. The contents are displayed in the form of a list including host names on the user terminal 50. On the list, information, including Web titles and other information, is sorted and indicated according to genre information and additional genre information. When the operator clicks the URL of the client terminal 40 on the list, the host name is extracted from the URL, and a request for conversion to an IP address is made. The Web browser 52 makes an inquiry about an IP address with reference to the host name, and the DNS server 20 returns an IP address for the client terminal 40. The Web browser 52 establishes a connection to the client terminal 40 by using the returned IP address, thereby enabling use of information from the Web server 44.

Needless to say, it is possible to establish a connection to the client terminal 40 without using the directory server 30. That is, the operator may click the URL stored in the user terminal in advance or may input a sequence of characters for the URL by himself/herself to enable the user terminal 50 to establish a connection to the client terminal 40. This procedure is used in a case where the state of the URL of the client terminal 40 is changed to the secrete state to prevent use of the directory server 30 with an intention to communicate information only to a limited group of users.

Further, in the WOD server 10 and the WOD client 42, a list may be prepared and stored in which a symbol for identification of user terminal 50 and URLs containing particular host names are entered by being related to each other. The user terminal 50 informs the WOD server 10 of a need to enter the user terminal 50 in the URL list in a state of being related to the Web server 44 which the user wishes to use. The WOD server 10 forms the URL list according to the information and transmits the user terminal 50 identification symbol entered in the URL list to the client terminal 40. The identification symbol is an IP address for the user terminal 50. If the user terminal has no IP address, the identification symbol is a user ID or the like. When the Web server 44 is activated, the WOD client 42 inquires of the WOD server 10 whether the user terminal 50 entered in the URL list is connected to the Internet and has logged in the WOD server 10 or is directly accessible. The WOD server 10 returns to the WOD client 42 an IP address for the user terminal 50 with which the user terminal 50 can be directly accessed. This IP address is an IP address in possession of the user terminal 50 or an IP address assigned by the ISP 60. With respect to user terminals 50 which the WOD client 42 cannot directly access, the WOD server 10 enters, in the URL list, information that the client terminal 40 is on-line. When the user terminal 50 logs in the WOD server 10, the WOD server 10 informs the user terminal 50 that the client terminal 40 is on-line, thereby reliably informing the user terminal 50 of the state of Web becoming usable by the user terminal 50 through the client terminal 40. If, for example, the user terminal 50 is in a firewall and cannot be accessed from the WOD client 42, the user terminal 50 may have a function of taking information from the WOD server 10 at certain time intervals.

In the WOD system in the above-described embodiment of the present invention, even the client terminal 40 whose IP address is not fixed can provide Web to the user terminal 50 at a request with a host name from the user terminal 50.

In the above-described WOD system, a Web service can be offered by using an arbitrary terminal through an arbitrary time period. Therefore, the WOD system is particularly advantageous in offering services described below.

<Live Relay Broadcasting>

If a digital camera and a dial-up environment are available, scenes in a sport event or a concert can be broadcast in a live relay broadcasting manner to a plurality of user terminals over the Internet. For example, a portable telephone or a handset in the personal handyphone system (PHS) is connected to a personal computer with a digital camera. In a simpler form, a portable telephone with a digital camera is connected to a client terminal.

<Temporary Web>

A Web site is held temporarily in an extraordinary or emergent situation. For example, a private resale market or the like, an auction, a sale (sold-out) information site, a television shopping-linked Web, and a presentation site are held. Also, if a personal Web server attached to Windows 2000 or Windows 98 (products of Microsoft Corporation) or streaming server such as Windows Media Service (product of Microsoft Corporation) is used, even a machine already provided with global IP addresses can also make a plurality of groups of Web. Therefore, the cost and labor for obtaining a plurality of machines and acquiring global IP addresses for the machines can be saved.

The preferred embodiment of the present invention has been described in the above. However, the present invention is not limited to the above-described embodiment and various modifications and changes of the described embodiment can be made without departing from the scope of the invention.

What is claimed is:

1. A Web on-demand system comprising:
receiving a client information including an IP address assigned to a client terminal and an arbitrary host name from the client terminal through the Internet; and
returning the IP address in response to an inquiry about the host name from a user terminal connected to the Internet while the client terminal is connected to the Internet.

2. A Web on-demand system according to claim 1, further comprising:
Web on-demand management server module for receiving the client information and for monitoring a state of connection of the client terminal to the Internet; and
DNS server module for newly registering the IP address and the host name with respect to the client terminal supplied from said Web on-demand management server module while relating the IP address and the host name to enable returning of the IP address in response to the inquiry about the host name from the user terminal connected to the Internet, and for deleting the registration of the client terminal when supplied with information that the connection of the client terminal to the Internet has been cut as information on the state of connection from said Web on-demand management server module.

3. A Web on-demand system according to claim 2, wherein the host name in the client information is registered in advance in said Web on-demand management server module while being related to the client terminal.

4. A Web on-demand system according to claim 2 or 3, wherein the host name is newly registered by said DNS server module in a state of being combined with a domain name maintained by said DNS server module to form a fully qualified domain name.

5. A Web on-demand system according to any one of claims 1 to 4, wherein a directory including the host name is provided at a request from the user terminal connected to the Internet while the client terminal is connected to the Internet.

6. A Web on-demand system according to claim 5, further comprising:
Web on-demand management server module for receiving the client information and for monitoring the state of connection of the client terminal to the Internet; and
directory server module for newly registering a URL including the host name supplied from said Web on-demand management server module to enable returning of the directory including the URL at a request from a user terminal connected to the Internet, and for deleting the registration of the client terminal when supplied with information that the connection of the client terminal to the Internet has been cut as information on the state of connection from said Web on-demand management server module.

7. A Web on-demand system according to claim 5 or 6, wherein the client information includes a title and genre information about Web which the client terminal will provide to the user terminal, and the directory is constituted by using the title and the genre information.

8. A Web on-demand system according to any one of claims 1 to 7, wherein a URL list in which a symbol for identification of the user terminal and a URL including the particular host name are entered by being related to each other is prepared in advance, and, when the client information is transmitted from the client terminal, the user terminal related to the host name is informed that the client information has been transmitted from the client terminal.

9. A Web on-demand system according to any one of claims 1 to 8, wherein a determination is made as to whether the client terminal is connected to the Internet from an alive signal periodically transmitted from the client terminal and/or an off-line signal transmitted from the client terminal when the client terminal is made off-line.
